(19) United States
(12) Patent Application Publication
(10) Pub. No.: US 2012/0296698 A1
(43) Pub. Date: Nov. 22, 2012

(54) Method and Apparatus of Forecasting Repurchase Inclination

(75) Inventor: Ningjun Su, Hangzhou (CN)

(73) Assignee: ALIBABA GROUP HOLDING LIMITED, Grand Cayman (US)

(21) Appl. No.: 13/059,456

(22) PCT Filed: Nov. 30, 2010
(86) PCT No.: PCT/US10/58361

§ 371 Date: Feb. 17, 2011

(30) Foreign Application Priority Data
Feb. 11, 2010 (CN) 201010111529.2

(51) Int. Cl. G06Q 30/02

(52) U.S. Cl. 705/7.31

(57) ABSTRACT

The present disclosure and data processing technology discloses a method and apparatus of forecasting repurchase inclinations of one or more clients. The disclosed technique improves the forecast accuracy of the clients' repurchasing inclination. The method includes: retrieving a list of a plurality of target clients from a specified storage location; determining historical benefits and a variation trend in historical benefits for at least one client based on respective historical benefits within a specified range of time; determining a purchasing power parameter and a degree of maturity for the client; computing a comfort level score for the client based on the respective historical trends, variation trend in historical benefits, purchasing power parameter, and degree of maturity; and determining a list of clients with repurchase inclination, the list of clients with repurchase inclination including those clients having a respective comfort level score satisfying a threshold condition.

### CROSS REFERENCE TO RELATED PATENT APPLICATIONS

This application is a national stage application of an international patent application PCT/US10/58361, filed Nov. 30, 2010, which claims priority from Chinese Patent Application No. 201010111529.2, filed Feb. 11, 2010, entitled “Method and Apparatus of Forecasting Repurchase Inclination,” which applications are hereby incorporated in their entirety by reference.

### TECHNICAL FIELD

The present disclosure relates to data processing technology and, more particularly, to the method and apparatus of forecasting clients' repurchase inclinations.

### BACKGROUND

With the development of technology and e-commerce gradually becoming an important method for company operations, companies utilize goods/services for client repurchase (including, for example, cross-selling, up-selling and extended marketing) to promote client value. Moreover, it is used to maintain the companies' capability to obtain continuous profit. This so-called repurchase is the act of purchasing goods/services from a company and to continue purchasing the same or similar product. Furthermore, cross-selling is the practice of selling additional goods or services to an existing client. Up-selling, on the other hand, is the practice of selling to existing clients goods/services of higher value. Moreover, extended selling is the practice of extending a contract after accomplishing a previous service.

Currently, the forecast analyses of a client's repurchase behavior commonly employ a data mining forecast analysis method. This method uses a client who had repurchased before as the sample client. After utilizing the forecast analysis method to establish a forecast analysis model and by using a decision tree and logic, one can arrive at a forecast for other clients' repurchase inclination. However, even by obtaining the quantity, stability and factors of the sample client's influence, the validity of forecast results may be difficult to be guaranteed. New products are also barely released due to lack of sample clients for consultation. The conventional data mining forecast method is also unable to implement the respective issues.

The conventional data mining forecast analysis method applied to the internet industry analyzes huge volumes of data (frequently 10 million on 100 million client data). As a result, the operation process tends to become complicated and encumbers on the system's resources. Furthermore, the computation time lengthens and it becomes difficult to satisfy the rapid business demands of the internet industry.

### SUMMARY OF THE DISCLOSURE

The present disclosure provides exemplary implementations of a method and apparatus for forecasting a client's repurchase inclination used to enhance its accuracy.

In one aspect, a computer-implemented method of forecasting repurchase inclination of one or more clients may comprise: retrieving a list of a plurality of target clients from a specified storage location, the list of the plurality of target clients identifying one or more target clients for which analysis of repurchase inclination is needed; determining historical benefits and a variation trend in historical benefits for at least one of the identified one or more target clients based on respective historical benefits within a specified range of time; determining a purchasing power parameter and a degree of maturity for the at least one of the identified one or more target clients; computing a comfort level score for the at least one of the identified one or more target clients based on the respective historical trends, variation trend in historical benefits, purchasing power parameter, and degree of maturity; and determining a list of clients with repurchase inclination, the list of clients with repurchase inclination including those clients having a respective comfort level score satisfying a threshold condition. The factors in determining the historical benefits of a client may include: an amount of monthly product exposure, an amount of monthly website clicks, an amount of monthly feedback, an amount of monthly purchase order, or a combination thereof.

The variation trend in historical benefit may follow changes in each factor of the historical benefits.

The formula HBT=(nΣxy−(Σx)(Σy))/(nΣX²−(ΣX)²) may be used for calculating the trend in historical benefits, and wherein n represents a quantity of historical benefits data, x represents data point serial numbering and y represents a monthly historical benefits value of a data point.

The client's purchasing power parameter may be related to an expected annual contract price, a highest contract price, an industry's average annual contract price, or a combination thereof.

The degree of maturity for the at least one of the identified one or more target clients may be related to the client's membership level, degree of network familiarity, degree of activeness, or a combination thereof.

The comfort level score of the at least one of the identified one or more target clients may be related to the client's historical benefits, variation trend in historical benefits, client expectations, or a combination thereof.

The method may further comprise generating a final marketing client list based on the list of clients with repurchase inclination. Additionally, a respective marketing plan may be selected for each client on the final marketing client list corresponding to a respective target product of each client on the final marketing client list.

In another aspect, an evaluation apparatus may comprise: an acquisition unit that retrieves a target client list from a specified storage location, the target client list identifying one or more target clients for which analysis of repurchase inclination is needed; a first computing unit that determines historical benefits and a variation trend in historical benefits for at least one of the identified one or more target clients based on respective historical benefits within a specified range of time, the first computing unit further determining a purchasing power parameter and a degree of maturity for each of the identified one or more target clients; a second computing unit that computes a comfort level score for at least one of the identified one or more target clients based on the respective historical trends, variation trend in historical benefits, purchasing power parameter, and degree of maturity; and a processing unit that generates a list of clients with repurchase inclination, the list of clients with repurchase inclination including those clients having a respective comfort level score satisfying a threshold condition.

The processing unit may further generate a final marketing client list based on the list of clients with repurchase inclination.

The evaluation apparatus may further comprise: a selection unit that selects a marketing plan corresponding to target products of those clients with repurchase inclination.

The factors in determining the historical benefits of a client may include: an amount of monthly product exposure, an amount of monthly website clicks, an amount of monthly feedback, an amount of monthly purchase order, or a combination thereof.

The variation trend in historical benefit may follow changes in each factor of the historical benefits.

The formula HBT=(nΣxy−(Σx)(Σy))/(nΣX²−(ΣX)²) may be used for determining the trend in historical benefits, and wherein n represents a quantity of historical benefits data, x represents data point serial numbering and y represents a monthly historical benefits value of a data point.

The client's purchasing power parameter may be related to an expected annual contract price, a highest contract price, an industry's average annual contract price, or a combination thereof.

The degree of maturity for the at least one of the identified one or more target clients may be related to the client's membership level, degree of network familiarity, degree of activeness, or a combination thereof.

The comfort level score of the at least one of the identified one or more target clients is related to the client's historical benefits, variation trend in historical benefits, client expectations, or a combination thereof.

The present disclosure provides an exemplary implementation on the re-definition of various parameters, such as client's historical benefits, trend in historical benefits, client's purchasing power and maturity and so on, in order to obtain user comfort level. Through this technique, the forecast of a client's repurchase inclination becomes more accurate for generating a final marketing client list. Therefore, it is through the user comfort level that the implementation of accurate product marketing plans can be better devised to promote products to result in higher marketing success rate. On the other hand, compared with the existing technology, the present disclosure offers a program to calculate the final marketing client list which can optimize operations. Accordingly, the technique can effectively lessen the load on the server(s) used for the implementation.

### DESCRIPTION OF DRAWINGS

FIG. 1 shows a three-factor analysis diagram according to an embodiment of the present disclosure.

FIG. 2 shows a client's psychological comfort diagram according to an embodiment of the present disclosure.

FIG. 3 shows a customer distribution curve diagram of psychological comfort according to an embodiment of the present disclosure.

FIG. 4 shows an assessment of the feature chart according to an embodiment of the present disclosure.

FIG. 5 shows an assessment of the client's repurchase inclination flow chart according to an embodiment of the present disclosure.

FIG. 6 shows schematics of the client's marketing repurchase inclination program according to an embodiment of the present disclosure.

### DETAILED DESCRIPTION

The present disclosure provides exemplary implementation based on the internal driving force theory, or the induced force-expectation theory and purchase motivation theory. These theories are used to influence a client's repurchase inclination where the main factors are attributed to: (1) historical benefits (in e-commerce these mainly refer to exposure, views, feedback, and trading volume received by product advertisements), (2) client's conditions (mainly referring to the economic strength of the client, advertising investment budget, etc.), and (3) goals to achieve (mainly referring to customer expectations of return on advertising investment). In these three aspects, self-analysis has been conducted.

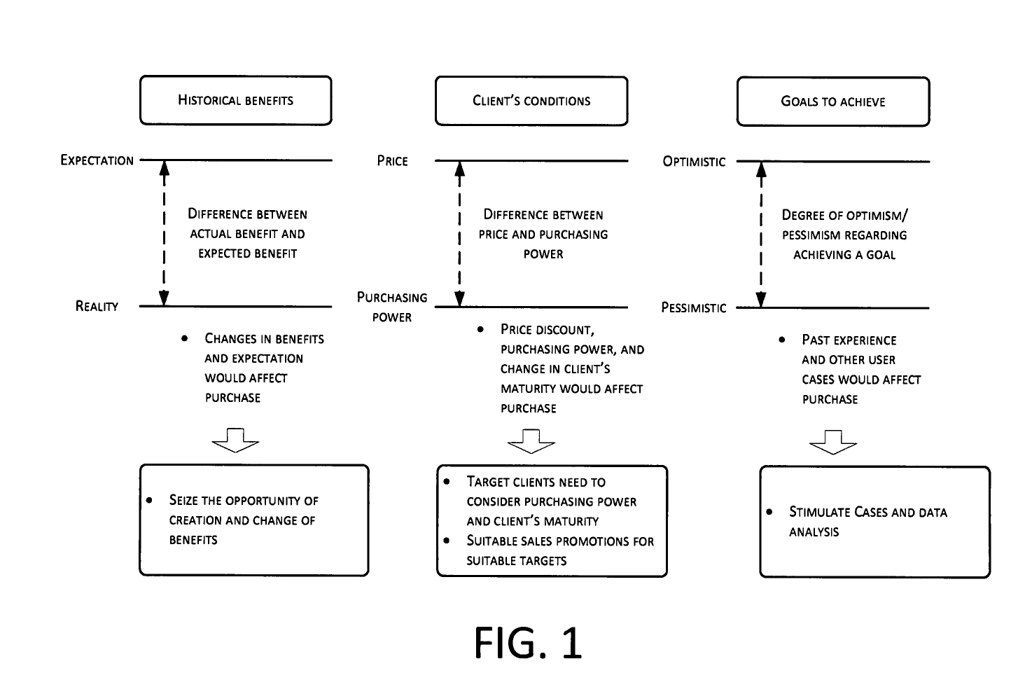

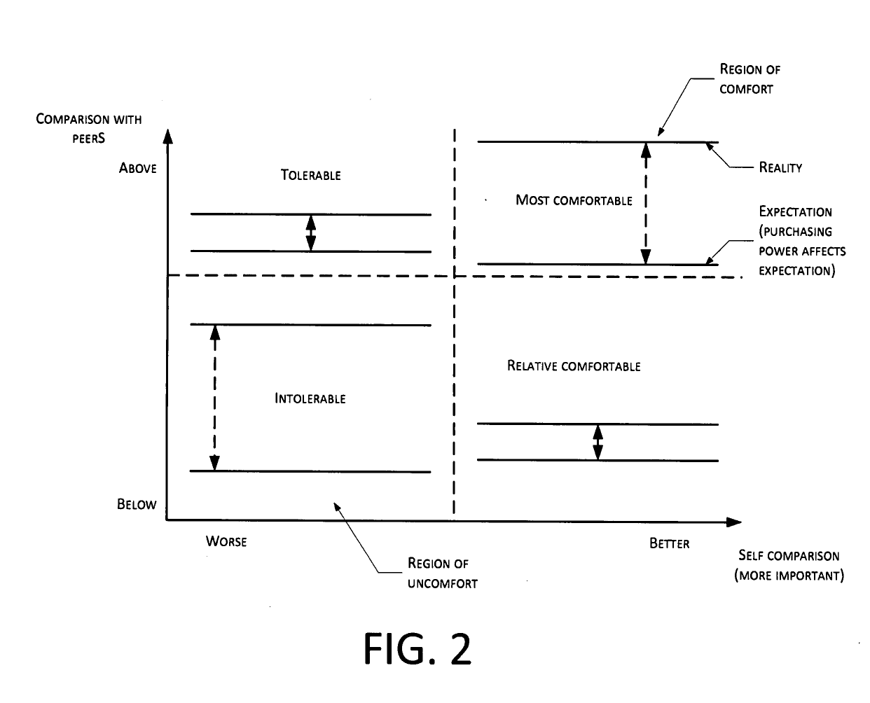

Referring to FIGS. 1 and 2, the determining factors of “historical benefits” include: the level of previous purchase (the measurement of the obtained advertisement feedback) and the changing trend of previous purchase benefit. The determining factors of “client's conditions” include: client's purchasing power, maturity, and acceptance of the price level. The determining factors of “goals to achieve” include: the purchase results that either have optimistic or pessimistic expectations. A client's optimistic expectation of “goals to achieve” may be stimulated through benefits already acquired and the success of others.

Among these three main attributes, the factor of historical benefits is the most important. Any change in historical benefits can directly influence the client's purchasing opportunity. If the client's “historical benefits” is relatively good, further variation in the trend of historical benefits tends to towards good development. Under such circumstances it is suitable to recommend to the client for repurchase. However, historical benefits can degenerate, or worsen. At the start of the worsening change, the likelihood of success in cross-selling of products to improve the client's benefits may be relatively high. Nevertheless, when the worsening change is unbearable for the client, it is considered a loss of marketing opportunity. In addition, if the client's “historical benefits” is poor and the change is worsening, then it is recommended that the client does not repurchase at such time. On the other hand, if the change is improving, it is a good time to recommend the client for repurchasing when the client distinctly perceives the improving change. There is no need to wait till the “historical benefits” is actually good to make such recommendation.

In short, when the client distinctly perceives the benefits of past purchases of goods/services the client is likely to be psychologically in a state of comfort, and thus the likelihood of success of marketing to the client for repurchase is higher. Otherwise, marketing efforts may cause the client to feel repugnant.

In one embodiment, a computer-implemented method of forecasting repurchase inclination of one or more clients comprises: retrieving a list of a plurality of target clients from a specified storage location, the list of the plurality of target clients identifying one or more target clients for which analysis of repurchase inclination is needed; determining historical benefits and a variation trend in historical benefits for at least one of the identified one or more target clients based on respective historical benefits within a specified range of time; determining a purchasing power parameter and a degree of maturity for the at least one of the identified one or more target clients; computing a comfort level score for the at least one of the identified one or more target clients based on the respective historical trends, variation trend in historical benefits, purchasing power parameter, and degree of maturity; and generating a final marketing client list based on a list of clients with repurchase inclination, the list of clients with repurchase inclination including those clients having a respective comfort level score satisfying a threshold condition. The following description is directed to detailed implementation of various embodiments.

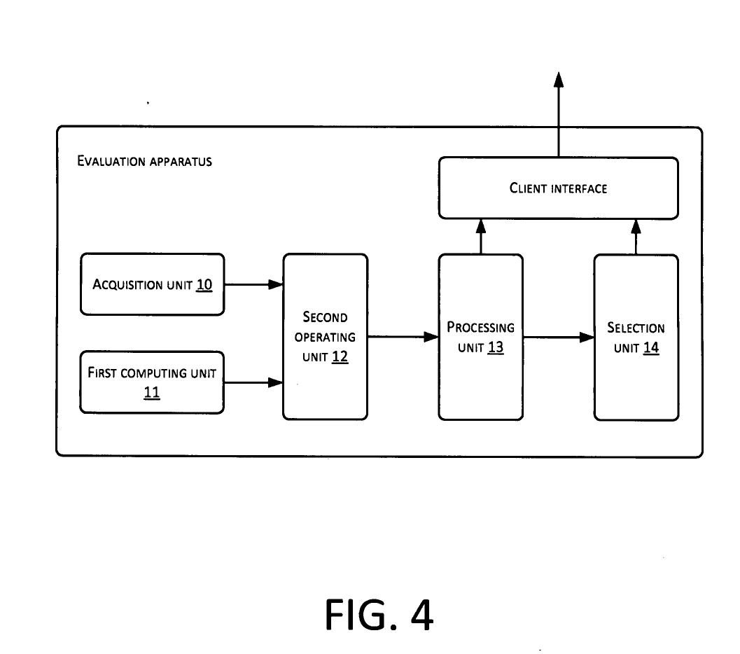

FIG. 4 illustrates an exemplary implementation of an evaluation apparatus on a client's repurchase inclination which comprising: an acquisition unit 10, a first computing unit 11, a second computing unit 12 and a processing unit 13.

The acquisition unit 10 retrieves a target client list from a specified storage location. The target client list identifies one or more target clients for which analysis of repurchase inclination is needed.

The first computing unit 11 determines historical benefits and a variation trend in historical benefits for each of the identified one or more target clients based on respective historical benefits within a specified range of time. The first computing unit 11 also determines a purchasing power parameter and a degree of maturity for each of the identified one or more target clients.

The second computing unit 12 computes a comfort level score for each of the identified one or more target clients based on the respective historical trends, variation trend in historical benefits, purchasing power parameter, and degree of maturity.

The processing unit 13 generates a final marketing client list based on a list of clients with repurchase inclination. The list of clients with repurchase inclination includes those clients having a respective comfort level score satisfying a threshold condition.

As shown in FIG. 4, the evaluation apparatus may optionally further comprise a selection unit 14 that selects a marketing plan corresponding to target products of those clients with repurchase inclination.

Those factors that may influence a client's comfort level score include: historical benefits, variation trend of a client's historical benefits, and client expectations. The evaluation of the historical benefits for a client can be done by comparing the client's historical benefits with those of one or more other clients (such as a peer client). Moreover, the client's expectation is correlated with the client's purchasing power. Generally, a client's expectation tends to be low when the purchasing power is strong, and vice versa. When the historical benefits are good, the variation trend in historical benefits is in an upward, or improving, direction, and the benefits already obtained surpass the client's expectation, the comfort level of the client is expected to be in a zone of highest comfort.

With respect to the above-mentioned factors, statistical analysis and comprehensive evaluation may be used to explore the variables, weight and function used to quantify all categories of influence. The following uses business-to-business (B2B) e-commerce industry as an example.

The current client's historical benefits can be expressed as:

HB=Σ(amount of monthly product exposure×a1+amount of monthly website clicks×a2+amount of monthly feedback×a3+amount of monthly purchase order×a4)×f(t) (Formula 1)

In Formula 1, the relationship between the weights a1, a2, a3 and a4 is as follows: a1<a2<a3<a4. In addition, Σai=1, f (t) is discount function of time, f(t)=exp(−t/12), and t denotes time interval to the current month.

The variation trend in client's historical benefits can be expressed as:

HBT=(nΣxy−(Σx)(Σy))/(nΣX²−(ΣX)²) (Formula 2)

In Formula 2, n is the quantity of HB (also referred to as data point figure), x is the data point serial numbering (but if the data is distributed in equidistance then use the natural number series 1, 2, 3 . . . . ), and y is the value of data point which is the monthly HB value (not considering discount for time).

Client's purchasing power can be expressed as:

PP=(expected annual contract price×b1+highest contract price×b2)+industry's average annual contract price×(number of employees/industry's average number of employees+average annual sales/industry's average annual sales)/2×b3 (Formula 3)

In Formula 3, the relationship between the weights b1, b2 and b3 is as follows: b1>b2>b3. In addition, Σbi=1.

Client's degree of maturity can be expressed as:

MG=(membership level×c1+degree of network familiarity×c2+degree of activeness×c3) (Formula 4)

In Formula 4, the relationship between the weights c1, c2 and c3 is as follows: c1>c2>c3. In addition, Σci=1.

From the above parameters, a client's comfort level score can be calculated with the following formula:

CG=(client's historical benefits and industry's average historical benefits ratio HB/AVG(HB)×d1+variation trend in historical benefits/absolute value of industry's average of all variation trends in historical benefits HBT/|AVG(HBT)|×d2+client's purchasing power/average value of purchasing power PP/AVG(PP)×d3+client's degree of maturity/average value of degree of maturity MG/AVG(MG)×d4) (Formula 5)

In Formula 5, the relationship between the weights d1, d2, d3 and d4 is as follows: d1>d2>d3>d4. In addition, Σdi=1.

The above-mentioned weights of variables, namely ai, bi, ci and di, may be assigned a value in accordance with a given method based on the system administrator's experience (e.g., Delphi method) or a comprehensive preset evaluation method. The illustration below may also be in accordance to plural preset methods, such as analytical hierarchy method, multivariate statistical method (factor analysis), and artificial neurological method and so on.

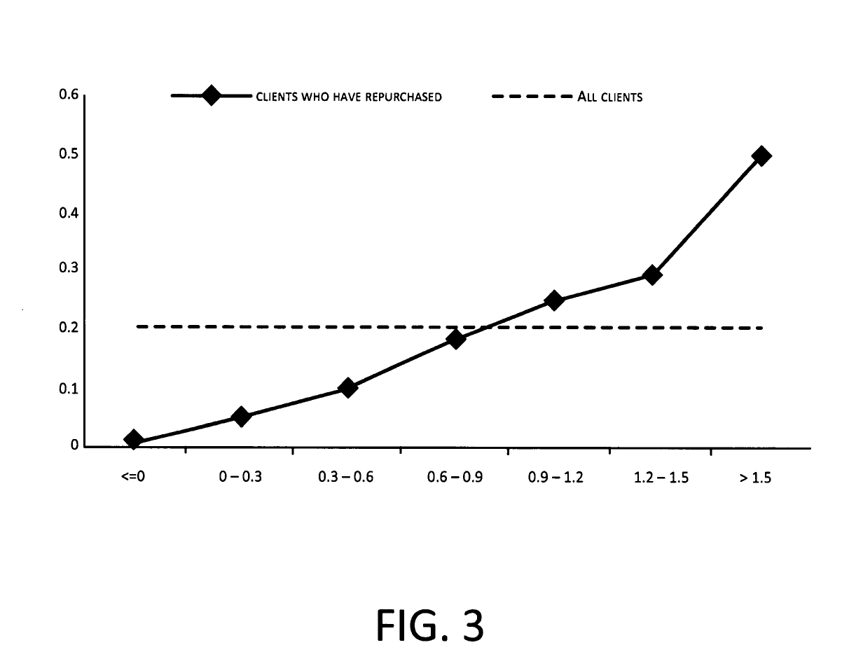

Based on the aforementioned method of obtaining a client's user comfort level, as shown in FIG. 3, there are distinct intervals of user comfort level scores. With the distribution graph of clients who had repurchased, one can determine the fixed conditions of clients with higher purchase inclination. If there are no samples of clients who had repurchased then evaluation can be directly based on the distribution and average of the user comfort level.

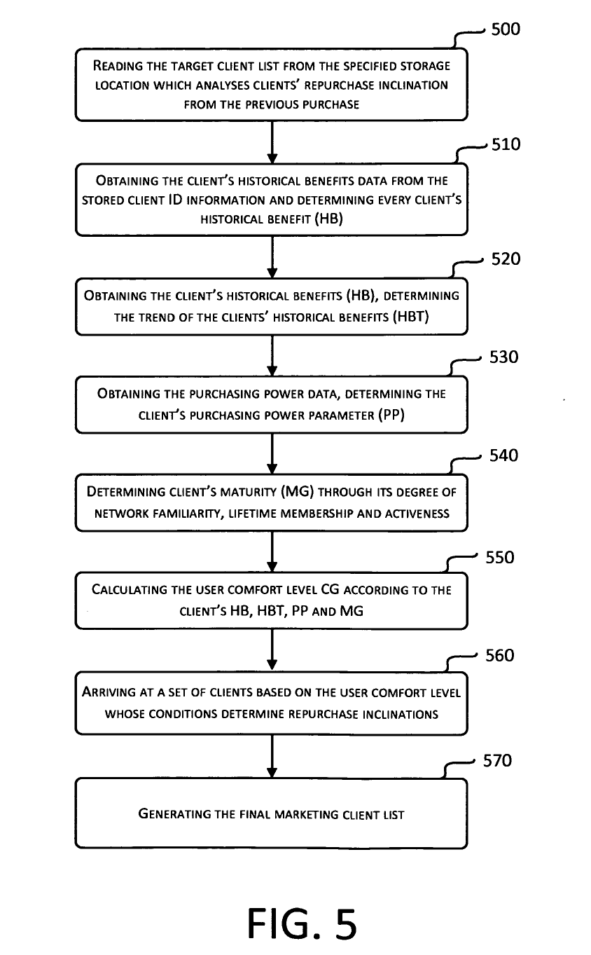

Based on the aforementioned principle, as shown in FIG. 5, a method of predicting repurchase by a client is described below.

At 500, the method retrieves a target client list from a specified storage location. The target client list identifies one or more target clients for which analysis of repurchase inclination is needed.

At 510, the method obtains data related to each client's historical benefits based on client identifications in the obtained target client list, and determines the historical benefits (HB) of each client.

For illustration purpose and as an example, a client's performance data for the six months of January through June may be that shown in Table 1 below.

TABLE 1

| | | Monthly | | | | |
|---|---|---|---|---|---|---|
| | Monthly | website | Monthly | Monthly | | Time- |
| | product | product | feed- | purchase | Monthly | discounted |
| Month | exposure | clicks | back | order | HB | monthly HB |
| 1 | 200 | 30 | 5 | 2 | 15.45 | 0.65924063 |
| 2 | 250 | 50 | 10 | 3 | 21.8 | 0.71653131 |
| 3 | 300 | 55 | 12 | 5 | 26.5 | 0.77880073 |
| 4 | 350 | 60 | 9 | 4 | 24.65 | 0.84648175 |
| 5 | 400 | 100 | 20 | 9 | 40.4 | 0.92004445 |
| 6 | 450 | 160 | 40 | 10 | 59.5 | 1 |
| Weight | 0.05 | 0.1 | 0.25 | 0.6 | | |
| ai | | | | | | |
| Current | | | | | | 4.92109883 |
| HB | | | | | | |
| HB | | | | | 7.83428574 | |
| Trend | | | | | | |

As shown in Formula 1, every variable based on the business importance and importance level of client's psychological influence, such as the relationship between the weights a1<a2<a3<a4, is set by the system administrator based on experience. Suppose that the weights are respectively set as follows: 0.05, 0.1, 0.25, and 0.6. Then, according to Formula 1, one can obtain the current value (for six months) of client's historical benefits as follows:

$$HB = ( 200 \times 0.05 + 30 \times 0.1 + 5 \times 0.25 + 2 \times 0.6 ) \times EXP ( ( 1 - 6 ) / 12 ) + ( 250 \times 0.05 + 50 \times 0.1 + 10 \times 0.25 + 3 \times 0.6 ) \times EXP ( ( 2 - 6 ) / 12 ) + ( 300 \times 0.05 + 55 \times 0.1 + 12 \times 0.25 + 5 \times 0.6 ) \times EXP ( ( 3 - 6 ) / 12 ) + ( 280 \times 0.05 + 60 \times 0.1 + 9 \times 0.25 + 4 \times 0.6 ) \times EXP ( ( 4 - 6 ) / 12 ) + ( 400 \times 0.05 + 100 \times 0.1 + 20 \times 0.25 + 9 \times 0.6 ) \times EXP ( ( 5 - 6 ) / 12 ) + ( 550 \times 0.05 + 160 \times 0.1 + 40 \times 0.25 + 10 \times 0.6 ) \times EXP ( ( 6 - 6 ) / 12 ) = 4.92$$

At 520, the method determines the variation trend in the clients' historical benefits (HBT) based on the obtained historical benefits value (HB).

y1=HB1=(200×0.05+30×0.1+5×0.25+2×0.6)=15.45

y2=HB2=(250×0.05+50×0.1+10×0.25+3×0.6)=21.8

y3=HB3=(300×0.05+55×0.1+12×0.25+5×0.6)=26.5

y4=HB4=(280×0.05+60×0.1+9×0.25+4×0.6)=24.65

y5=HB5=(400×0.05+100×0.1+20×0.25+9×0.6)=40.4

y6=HB6=(550×0.05+160×0.1+40×0.25+10×0.6)=59.5

x1=1,x2=2,x3=3,x4=4,x5=5,x6=6

Based on Formula 2, one can obtain HBT=7.83.

At 530, the method determines the client's purchasing power parameter (PP) based on data related to client purchase potential.

For illustration purpose and as an example, suppose the purchase potential of a client can be expressed as that shown in Table 2 below.

TABLE 2

| | | | | | | | Industry's |
|---|---|---|---|---|---|---|---|
| | Average | | Average | | Industry's | Average | average |
| | Annual | Highest | Industry's | Number | average | Annual | annual |
| Purchasing | Contract | Contract | Contract | of | annual | Sales | sales |
| power of | Price | Price | Price | employees | sales | (000) | (000) |
| the data | 3800 | 5800 | 3500 | 15 | 10 | 150 | 120 |

| | | | |
|---|---|---|---|
| bi | 0.5 | 0.3 | 0.2 |

According to Formula 3, a client's purchasing power parameter can be obtained as follows:

PP=3800×0.5+5800×0.3+3500×(15/10+150/120)/2×0.2=4602.5

At 540, the method determines the client's degree of maturity (MG) according to the client's degree of network familiarity, membership level, and degree of activeness.

The value of membership level can be set to 1 when the client has been a member for no more than one year, set to 2 when the client has been a member for no more than two years, and set to 3 when the client has been a member for no more than three years.

The degree of network familiarity can be set to 1 when there is no company website or professional staff, set to 2 when there is either a company website or professional staff but no other e-commerce platform has been used, and set to 3 when there is either a company website or professional staff and one or more other e-commerce platforms have been used.

The degree of activeness can be set to 1 when on average the client spends no more than two hours per day, set to 2 when on average the client spends no more than four hours per day, and set to 3 when on average the client spends more than four hours per day.

According to Formula 4, a client's degree of maturity (MG) can be obtained as follows:

MG=2×0.5+3×0.3+2×0.2=2.3

At 550, the method calculates the client's user comfort level (CG) according to the client's HB, HBT, PP and MG.

Data analysis and research have shown that a client's HB, HBT, PP and MG are associated with CG. That is, the better the historical benefits get, the higher the user comfort level will be. When the trend in benefits rises significantly, the user comfort level also increases. Furthermore, the stronger the client's purchasing power is, the lower their expectation and the higher the user comfort level will be. In addition, the higher the degree of maturity level of the client is, the more reasonable their expectation will be with still higher user comfort level.

In one embodiment, when calculating the user comfort level, the method first computes the average values of the obtained HB, HBT, PP and MG as follows: AVG (HB)=4, AVG (HBT)=8, AVG (PP)=3800, AVG (MG)=1.8.

According to Formula 5 and based on market research, the weight of every factor can be determined to calculate the user comfort level as follows:

CG=4.92/4×0.5+7.83/8×0.2+4602.5/3800×0.2+2.3/1.8×0.1=1.18

At 560, based on the user comfort level, the method identifies a set of clients whose respective user comfort level meets certain condition as a set of clients with repurchase inclination.

For example, FIG. 3 shows a distribution diagram of the user comfort level. When the comfort value is >0.9, client's repurchase inclination is relatively higher. As the repurchase inclination interval is greater than the overall level (20%), the aforementioned value would be 1.18 in user comfort level, thus determining the client's repurchase inclination.

At 570, the method generates a final marketing client list based on the set of clients with repurchase inclination.

In practice, cross-selling and up-selling of goods can be conducted based on the generated final marketing client list.

Based on the aforementioned exemplary implementation, it is possible to predict accurately potential clients' repurchase inclination by means of client historical benefits, analysis of the variation trend in historical benefits, as well as comprehensively the purchasing power, the degree of maturity and the value of user comfort level. Subsequently, marketing effort can be focused on those clients with high likelihood of repurchase, for example, such as those clients with a use comfort level greater than 0.9.

If the variation trend in historical benefits HBT of a client is negative, meaning the value of benefits starts to decline, then it is implied that the user comfort level of the client is likely to be impacted and thus attention should be paid to such a client as early as possible.

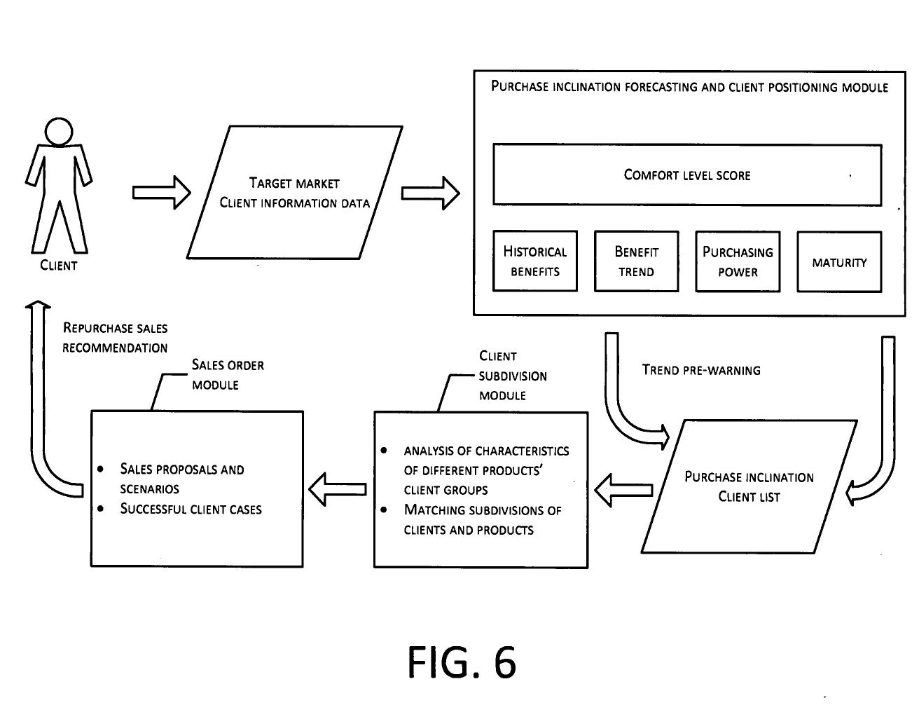

Based on the analysis of repurchase inclination, once the target clients for marketing effort have been identified, clients likely to purchase can be matched with corresponding product(s) according to characteristics of the clients. The clients matched with corresponding products) can be further categorized according to purchase inclination. Corresponding marketing plans can be devised and success story/stories of customers using the product(s) can be provided to stimulate client desire to purchase the product(s), as shown in FIG. 6.

In summary, the present disclosure provides an exemplary implementation on the re-definition of various parameters, such as client's historical benefits, trend in historical benefits, client's purchasing power and maturity and so on, in order to obtain user comfort level. Through this technique, the forecast of a client's repurchase inclination becomes more accurate for generating a final marketing client list. Therefore, it is through the user comfort level that the implementation of accurate product marketing plans can be better devised to promote products to result in higher marketing success rate. On the other hand, compared with the existing technology, the present disclosure offers a program to calculate the final marketing client list which can optimize operations. Accordingly, the technique can effectively lessen the load on the server(s) used for the implementation.

On the other hand, the present disclosure resolves problems in the quality and stability of sample clients encountered by conventional data mining and forecast techniques. With conventional techniques, the validity of forecast results frequently makes it hard to guarantee the quality and new products are barely released due to lack of sample clients to consult.

Clearly, a person of ordinary skill in the art can alter or modify the present disclosure in many different ways without departing from the spirit and the scope of this disclosure. Accordingly, it is intended that the present disclosure covers all modifications and variations, which fall within the scope of the claims of the present disclosure, and their equivalent.

What is claimed is:

1. A computer-implemented method of forecasting repurchase inclination of one or more clients, the method comprising:
retrieving a list of a plurality of target clients from a specified storage location, the list of the plurality of target clients identifying one or more target clients for which analysis of repurchase inclination is needed;
determining historical benefits and a variation trend in historical benefits for at least one of the identified one or more target clients based on respective historical benefits within a specified range of time;
determining a purchasing power parameter and a degree of maturity for the at least one of the identified one or more target clients;
computing a comfort level score for the at least one of the identified one or more target clients based on the respective historical trends, variation trend in historical benefits, purchasing power parameter, and degree of maturity; and
determining a list of clients with repurchase inclination, the list of clients with repurchase inclination including those clients having a respective comfort level score satisfying a threshold condition.

2. The method as recited in claim 1, wherein factors in determining the historical benefits of a client include: an amount of monthly product exposure, an amount of monthly website clicks, an amount of monthly feedback, an amount of monthly purchase order, or a combination thereof.

3. The method as recited in claim 2, wherein the variation trend in historical benefit follows changes in each factor of the historical benefits.

4. The method as recited in claim 1, wherein the formula HBT=(nΣxy−(Σx)(Σy))/(nΣX²−(ΣX)²) is used for calculating the trend in historical benefits, and wherein n represents a quantity of historical benefits data, x represents data point serial numbering and y represents a monthly historical benefits value of a data point.

5. The method as recited in claim 1, wherein the client's purchasing power parameter is related to an expected annual contract price, a highest contract price, an industry's average annual contract price, or a combination thereof.

6. The method as recited in claim 1, wherein the degree of maturity for the at least one of the identified one or more target clients is related to the client's membership level, degree of network familiarity, degree of activeness, or a combination thereof.

7. The method as recited in claim 1, wherein the comfort level score of the at least one of the identified one or more target clients is related to the client's historical benefits, variation trend in historical benefits, client expectations, or a combination thereof.

8. The method as recited in claim 1, further comprising:
generating a final marketing client list based on the list of clients with repurchase inclination.

9. The method as recited in claim 8, further comprising:
selecting a respective marketing plan for each client on the final marketing client list corresponding to a respective target product of each client on the final marketing client list.

10. An evaluation apparatus, comprising:
an acquisition unit that retrieves a target client list from a specified storage location, the target client list identifying one or more target clients for which analysis of repurchase inclination is needed;
a first computing unit that determines historical benefits and a variation trend in historical benefits for at least one of the identified one or more target clients based on respective historical benefits within a specified range of time, the first computing unit further determining a purchasing power parameter and a degree of maturity for each of the identified one or more target clients;
a second computing unit that computes a comfort level score for at least one of the identified one or more target clients based on the respective historical trends, variation trend in historical benefits, purchasing power parameter, and degree of maturity; and
a processing unit that generates a list of clients with repurchase inclination, the list of clients with repurchase inclination including those clients having a respective comfort level score satisfying a threshold condition.

11. The evaluation apparatus as recited in claim 10, wherein the processing unit further generates a final marketing client list based on the list of clients with repurchase inclination.

12. The evaluation apparatus as recited in claim 10, further comprising:
a selection unit that selects a marketing plan corresponding to target products of those clients with repurchase inclination.

13. The evaluation apparatus as recited in claim 10, wherein factors in determining the historical benefits of a client include: an amount of monthly product exposure, an amount of monthly website clicks, an amount of monthly feedback, an amount of monthly purchase order, or a combination thereof.

14. The evaluation apparatus as recited in claim 13, wherein the variation trend in historical benefit follows changes in each factor of the historical benefits.

15. The evaluation apparatus as recited in claim 10, wherein the formula HBT=(nΣxy−(Σx)(Σy))/(nΣX²−(ΣX)²) is used for determining the trend in historical benefits, and wherein n represents a quantity of historical benefits data, x represents data point serial numbering and y represents a monthly historical benefits value of a data point.

16. The evaluation apparatus as recited in claim 10, wherein the client's purchasing power parameter is related to an expected annual contract price, a highest contract price, an industry's average annual contract price, or a combination thereof.

17. The evaluation apparatus as recited in claim 10, wherein the degree of maturity for the at least one of the identified one or more target clients is related to the client's membership level, degree of network familiarity, degree of activeness, or a combination thereof.

18. The evaluation apparatus as recited in claim 10, wherein the comfort level score of the at least one of the identified one or more target clients is related to the client's historical benefits, variation trend in historical benefits, client expectations, or a combination thereof.
